(19) United States
(12) Patent Application Publication
(10) Pub. No.: US 2026/0055855 A1
(43) Pub. Date: Feb. 26, 2026

(54) SYSTEMS AND METHODS FOR EMERGENCY PREVENTION AND CONTROL FOR URBAN LIFELINE GAS PIPELINES DURING FLOODING BASED ON A LARGE MODEL

(71) Applicant: CHENGDU QINCHUAN IOT TECHNOLOGY CO., LTD., Chengdu (CN)

(72) Inventors: Hanshu SHAO, Chengdu (CN); Junyan ZHOU, Chengdu (CN); Guobin LUO, Chengdu (CN)

(73) Assignee: CHENGDU QINCHUAN IOT TECHNOLOGY CO., LTD., Chengdu (CN)

(21) Appl. No.: 19/373,971

(22) Filed: Oct. 30, 2025

(30) Foreign Application Priority Data
Sep. 24, 2025 (CN) 202511371862.X

(51) Int. Cl. F17D 5/00; F17D 5/02

(52) U.S. Cl. CPC F17D 5/005; F17D 5/02

(57) ABSTRACT

A system for emergency prevention and control for urban lifeline gas pipelines during flooding based on a large model is provided. The system includes an emergency supervision-management platform configured to: construct a gas pipeline network map based on pipeline pressures and gas flow rates of a plurality of pipeline nodes; determine a plurality of suspected leakage points and a plurality of leakage confidence levels of the plurality of suspected leakage points; perform an evaluating process on each suspected leakage point; determine, based on a plurality of corrosion risks and a plurality of deformation risks of the plurality of suspected leakage points, a comprehensive risk of a target pipeline node using a prediction model; and in response to the comprehensive risk meeting a drainage condition, automatically send a control signal to a drainage robot to drive the drainage robot to carry out drainage.

### CROSS-REFERENCE TO RELATED APPLICATIONS

This application claims the priority of Chinese Patent Application No. 202511371862.X, filed on September 24, 2025, the contents of which are hereby incorporated by reference.

### TECHNICAL FIELD

The present disclosure relates to the technical field of emergency response for gas pipelines during flooding, and in particular relates to a system and method for emergency prevention and control for urban lifeline gas pipelines during flooding based on a large model.

### BACKGROUND

Gas pipelines are critical components of urban lifeline projects. Prolonged immersion in flooding and scouring by water flow can not only accelerate the chemical corrosion of the gas pipelines but may also cause physical deformation of the gas pipelines due to uneven settlement of foundations, significantly increasing the risk of gas leakage and posing a serious threat to public safety.

Traditional risk assessment models for gas pipeline networks are unable to effectively integrate multiple environmental parameters during flooding, such as water depth and water composition, thus failing to conduct real-time and accurate risk assessments.

Therefore, it is necessary to provide a system and method for emergency prevention and control for urban lifeline gas pipelines during flooding based on a large model to improve efficiency and the quality of risk monitoring.

### SUMMARY

One or more embodiments of the present disclosure provide a method for emergency prevention and control for urban lifeline gas pipelines during flooding based on a large model. The method includes: constructing a gas pipeline network map based on pipeline pressures and gas flow rates of a plurality of pipeline nodes; determining a plurality of suspected leakage points and a plurality of leakage confidence levels of the plurality of suspected leakage points; and performing an evaluating process on each suspected leakage point of the plurality of suspected leakage points, wherein

the evaluating process includes: determining a sampling radius based on the leakage confidence level of the suspected leakage point; controlling an inspection robot to travel to the suspected leakage point to collect water data; controlling an unmanned aircraft to move to the suspected leakage point to collect image data; and determining a corrosion risk and a deformation risk of the suspected leakage point based on the water data and the image data; determining, based on a plurality of corrosion risks and a plurality of deformation risks of the plurality of suspected leakage points, a comprehensive risk of a target pipeline node using a prediction model; and in response to the comprehensive risk meeting a drainage condition, automatically sending a control signal to a drainage robot to drive the drainage robot to carry out drainage.

One of the embodiments of the present disclosure provides a system for emergency prevention and control for urban lifeline gas pipelines during flooding based on a large model. The system includes an emergency supervision-management platform. The emergency supervision-management platform is configured to perform a method for emergency prevention and control for urban lifeline gas pipelines during flooding based on a large model.

### BRIEF DESCRIPTION OF THE DRAWINGS

The present disclosure will be further illustrated by way of exemplary embodiments, which will be described in detail by way of the drawings. These embodiments are not limiting, and in these embodiments, the same numeral denotes the same structure.

FIG. 1 is a module diagram of an exemplary system for emergency prevention and control for urban lifeline gas pipelines during flooding based on a large model according to some embodiments of the present disclosure;

FIG. 2 is a flowchart of an exemplary method for emergency prevention and control for urban lifeline gas pipelines during flooding based on a large model according to some embodiments of the present disclosure; and

FIG. 3 is an exemplary flowchart of a prediction model according to some embodiments of the present disclosure.

### DETAILED DESCRIPTION

In order to more clearly illustrate the technical solutions of the embodiments of the present disclosure, a brief description of the drawings that need to be used in the description of the embodiments is provided below. Obviously, the drawings in the following description are only some examples or embodiments of the present disclosure, and it is possible for those skilled in the art to apply the present disclosure to other similar scenarios according to these drawings without creative labor. Unless obviously obtained from the context or the context illustrates otherwise, the same numeral in the drawings refers to the same structure or operation.

It should be understood that, as used herein, the terms "system", "device", "unit", and/or "module" are used herein as a way to distinguish between different components, elements, parts, sections, or assemblies at different levels. However, the words may be replaced by other words if the other words accomplish the same purpose.

As shown in the present disclosure and the claims, unless the context clearly suggests an exception, the words "a", "an ", and/or "the" do not refer specifically to the singular, but may also include the plural. Generally, the terms "including" and "comprising" only suggest the inclusion of explicitly identified steps and elements that do not constitute an exclusive list, and the method or apparatus may also include other steps or elements.

Flowcharts are used in the present disclosure to illustrate operations performed by a system according to some embodiments of the present disclosure. It should be appreciated that the preceding operations or the following operations are not necessarily performed in an exact sequence. Instead, the steps may be processed in reverse order or simultaneously. Also, it is possible to add other operations to these processes or remove a step or steps from these processes.

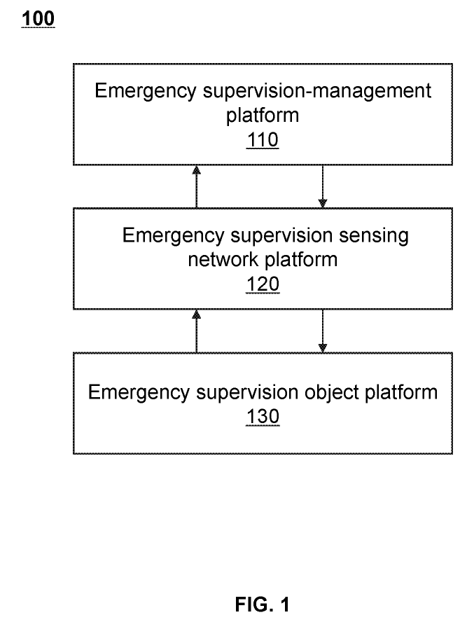

FIG. 1 is a module diagram of an exemplary system for emergency prevention and control for urban lifeline gas pipelines during flooding based on a large model according to some embodiments of the present disclosure.

In some embodiments, a system 100 for emergency prevention and control for urban lifeline gas pipelines during flooding based on a large model (hereinafter referred to as the system) includes an emergency supervision-management platform 110, an emergency supervision sensing network platform 120, and an emergency supervision object platform 130.

The emergency supervision-management platform 110 (hereinafter referred to as a management platform) refers to an integrated management platform that manages the integration and coordination of links and collaboration of a plurality of platforms. The management platform may be configured as a server or a processor. In some embodiments, the emergency supervision-management platform 110 is communicatively connected to the emergency supervision object platform 130 via the emergency supervision sensing network platform 120.

In some embodiments, the management platform is configured to: construct a gas pipeline network map based on pipeline pressures and gas flow rates of a plurality of pipeline nodes; determine a plurality of suspected leakage points and a plurality of leakage confidence levels of the plurality of suspected leakage points; perform an evaluating process on each suspected leakage point of the plurality of suspected leakage points; determine, based on a plurality of corrosion risks and a plurality of deformation risks of the plurality of suspected leakage points, a comprehensive risk of a target pipeline node using a prediction model; and in response to the comprehensive risk meeting a drainage condition, automatically send a control signal to a drainage robot to drive the drainage robot to carry out drainage. The evaluating process includes: determining a sampling radius based on the leakage confidence level of the suspected leakage point; controlling an inspection robot to travel to the suspected leakage point to collect water data; controlling an unmanned aircraft to move to the suspected leakage point to collect image data; and determining a corrosion risk and a deformation risk of the suspected leakage point based on the water data and the image data.

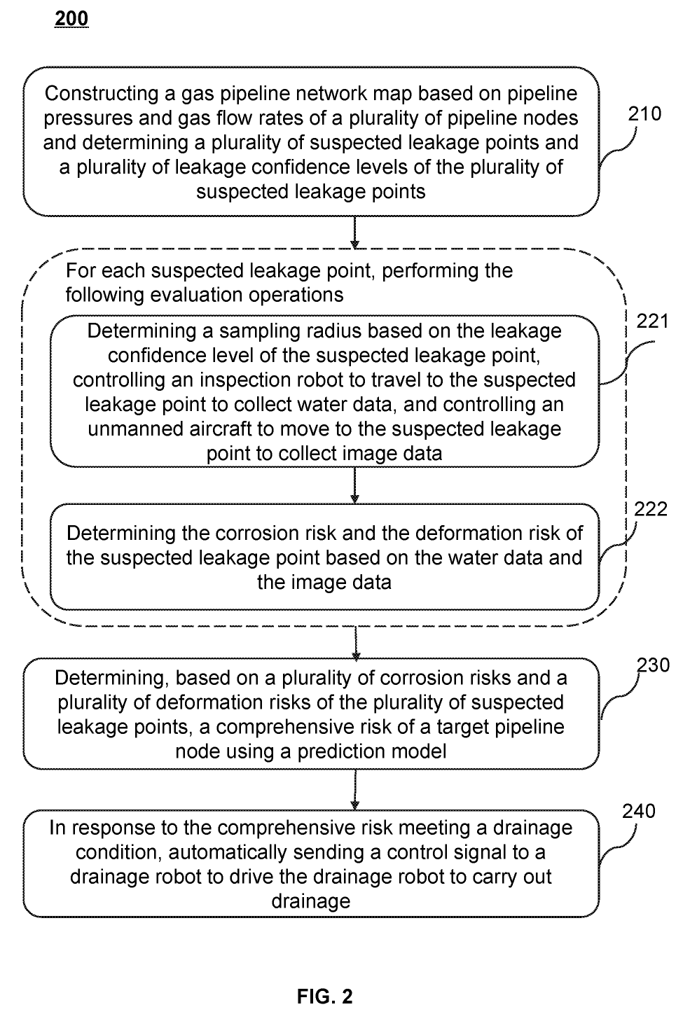

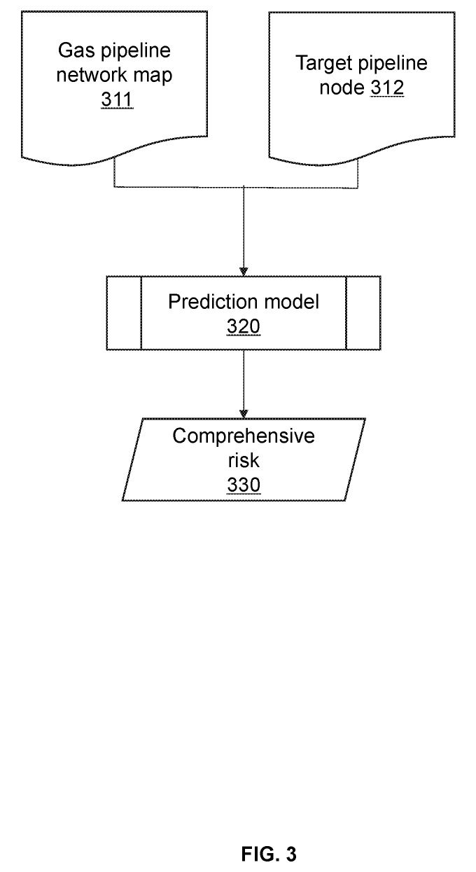

More descriptions regarding the management platform may be found in FIG. 2 - FIG. 3 and related descriptions thereof.

The emergency supervision sensing network platform 120 is configured to comprehensively manage sensing information and is a communication-transmission platform for realizing two-way data interaction between the management platform 110 and the emergency supervision object platform 130. In some embodiments, the emergency supervision sensing network platform 120 may be configured as a device (e.g., a communication network or a gateway). The emergency supervision sensing network platform 120 uploads real-time sensing data acquired by the emergency supervision object platform 130 to the emergency supervision-management platform 110, and sends regulating commands generated at the emergency supervision-management platform 110 to a corresponding emergency supervision object platform 130 to perform operations.

The emergency supervision object platform 130 refers to a platform for the generation of supervision information and the execution of control information. In some embodiments, the emergency supervision object platform 130 may include a plurality of types of sensors (e.g., pressure sensors and flow meters), inspection robots, unmanned aircraft, drainage robots, valves, and protection electrodes deployed at key nodes of gas pipeline networks. The emergency supervision object platform 130 is configured to collect real-time data of gas pipelines and the surrounding environment of the gas pipelines, and upload the real-time data through the emergency supervision sensing network platform 120. At the same time, the emergency supervision object platform 130 performs specific emergency operations (e.g., automatically closing the valves, starting the inspection robot, or scheduling the drainage robot to carry out the drainage) in response to receiving the regulating commands sent from the emergency supervision-management platform 110.

The large model refers to a model architecture for the field of Internet of Things (IoT), which is also referred to as an IoT model architecture. The IoT model architecture is configured to enable efficient flow and processing of massive data within the system. The IoT model architecture also includes an AI model (e.g., ChatGPT and other language models), which may be applied to the IoT model architecture to facilitate data sensing and processing.

In some embodiments of the present disclosure, by using the system for emergency prevention and control for urban lifeline gas pipelines during flooding based on the large model, emergency supervision-management of the gas pipelines during flooding can be carried out automatically to carry out risk assessment and emergency response, and to promptly eliminate the risk of gas leakage, pipeline damage, and other safety hazards due to the flooding.

FIG. 2 is a flowchart of an exemplary method for emergency prevention and control for urban lifeline gas pipelines during flooding based on a large model according to some embodiments of the present disclosure. As shown in FIG. 2, a process 200 includes operations 210-240 as described below. In some embodiments, the process 200 may be executed by an emergency supervision-management platform at a preset interval. The preset interval may be set by a technician based on experience. For example, the preset interval may be 1 min or 5 min.

In 210, a gas pipeline network map is constructed based on pipeline pressures and gas flow rates of a plurality of pipeline nodes, and a plurality of suspected leakage points and a plurality of leakage confidence levels of the plurality of suspected leakage points are determined.

The pipeline node (also referred to as a node) refers to a component or a key location that has a specific function during gas transmission or distribution. For example, the pipeline node may refer to a branching point or a pooling point of a pipeline, a location in the pipeline where a valve is located, etc. The emergency supervision-management platform (hereinafter referred to as a management platform) may obtain the pipeline nodes that are entered by a technician.

The pipeline pressures and the gas flow rates may be acquired by pressure sensors and flow meters of an emergency supervision object platform.

The gas pipeline network map refers to a map that can reflect connection relationships among gas pipelines (also referred to as pipelines) and valves, the pressure sensors, the flow meters, etc., connected to the gas pipeline. In some embodiments, the gas pipeline network map is a data structure consisting of nodes and edges, with the edges connecting the nodes, and the nodes and the edges having attributes.

In some embodiments, a node of the gas pipeline network map may correspond to a pipeline node. For example, the nodes of the gas pipeline network map correspond to the valves or the branching points of the pipelines. An attribute of each node (also referred to as a nodal attribute) may reflect relevant features of a corresponding pipeline or a corresponding valve. For example, the nodal attribute of the node includes: a pipeline pressure and a gas flow rate of the node, and an opening degree of a valve. In some embodiments, the nodal attribute includes a corrosion risk and a deformation risk. More descriptions regarding the corrosion risk and the deformation risk may be found in the following descriptions.

In some embodiments, the management platform may obtain the nodal attributes of the nodes from the emergency supervision object platform.

In some embodiments, the edges of the gas pipeline network map may correspond to gas pipelines that exist between the nodes. The edge is a directed edge, and a direction of the edge reflects a direction of gas flow between the nodes. An edge attribute of each edge may include features of the corresponding pipeline. The features of the pipeline include a pipeline length, a pipeline material, a pipeline age, a diameter, a burial depth, etc. The edge attributes of the edges may be entered by the technician.

The suspected leakage point refers to a pipeline node with data anomalies where a leak is likely to occur.

In some embodiments, the suspected leakage point is obtained by: determining, based on the gas pipeline network map, a theoretical pressure and a theoretical flow rate of a next node of each node; comparing the theoretical pressure and the theoretical flow rate of the next node with an actual measured pipeline pressure and an actual measured gas flow rate of the next node to obtain a pressure difference and a flow rate difference; and in response to the pressure difference being greater than a corresponding pressure difference threshold or the flow rate difference being greater than a corresponding flow rate difference threshold, determining the next node as a suspected leakage point by the management platform.

The next node and a previous node refer to a next pipeline node and a previous pipeline node, respectively, that are connected to the node. The next node and the previous node may be determined based on the edges in the gas pipeline network map. The theoretical pressure and the theoretical flow rate may be calculated in various ways. For example, the theoretical pressure and the theoretical flow rate may be simulated by hydrodynamic simulation software or calculated by hydrodynamic formulas (e.g., Bernoulli's equations and Hagen-Poissuet's equations). The corresponding pressure difference threshold and the corresponding flow rate difference threshold may be empirically preset.

An excessively large difference between the actual measured pipeline pressure and the theoretical pressure or between the actual measured gas flow rate and the theoretical flow rate of a gas node indicates that there may be a leak between the gas nodes.

The leakage confidence level refers to a real possibility of leakage at the suspected leakage point. The leakage confidence level may be expressed as a real number, a percentage, a grade, etc. For example, the leakage confidence level may be a value between 0 and 1.

In some embodiments, after identifying the suspected leakage points, for each suspected leakage point, the management platform constructs a feature vector based on the nodal attribute of the suspected leakage point, a nodal attribute of a previous node of the suspected leakage point, and an edge attribute of an edge between the suspected leakage point and the previous node; and determines the leakage confidence level of each suspected leakage point based on a retrieval result of the feature vector in a vector database.

The vector database includes a plurality of reference vectors and a leakage confidence level corresponding to each reference vector. The reference vectors are constructed based on the nodal attributes of the suspected leakage points, the nodal attributes of the previous nodes of the suspected leakage points, and the edge attributes of the edges between the suspected leakage points and the corresponding previous nodes in historical data. The management platform may select a leakage confidence level corresponding to a reference vector with the smallest vector distance as the leakage confidence level by calculating vector distances between the feature vector and each of the reference vectors.

In some embodiments, the vector database may be constructed based on historical pipeline leakage information. For example, the leakage confidence level for each suspected leakage point may be a ratio of a count of leakages that occurred at the suspected leakage point to a maximum value among counts of leakages, each of which occurred at a node of all nodes in the historical pipeline leakage information. For example, if the maximum value among the counts of leakages, each of which corresponds to a node of all pipeline nodes, is 10, and the count of leakages that occurred at the suspected leakage point is 8, the leakage confidence level is 80%. The historical pipeline leakage information may be obtained from the management platform.

In some embodiments, for each suspected leakage point, the following evaluation operations 221-222 are performed.

In 221, a sampling radius is determined based on the leakage confidence level of the suspected leakage point, an inspection robot is controlled to travel to the suspected leakage point to collect water data, and an unmanned aircraft is controlled to move to the suspected leakage point to collect image data.

The sampling radius refers to a collection range for data collection centered on the suspected leakage point.

In some embodiments, the sampling radius is directly proportional to the leakage confidence level. A specific proportional relationship may be preset. For example, a sampling radius is 30 meters with a leakage confidence level of 0.8, or a sampling radius is 2 meters with a leakage confidence level of 0.2. The higher the leakage confidence level, the higher the likelihood of leakage at the suspected leakage point. Therefore, a larger sampling range and a larger sampling radius are needed.

In some embodiments, after determining the sampling radius, the management platform may determine a sampling quantity and sampling locations. For example, the sampling quantity may be a fixed value, and the sampling locations are locations of sampling points arranged at an equal distance.

In some embodiments, the management platform determines the sampling quantity and the sampling locations of a plurality of sampling points within the sampling radius based on the pipeline material and a soaking time of the suspected leakage point; and automatically controls the inspection robot and the unmanned aircraft to sample based on the sampling quantity and the sampling locations of the plurality of sampling points.

The soaking time refers to a cumulative duration that the pipeline has been soaked in water due to the flooding. In some embodiments, the soaking time may be calculated from sensing data from a water level sensor. The emergency supervision sensing network platform also deploys a water level sensor (e.g., a float-type sensor), which is used to monitor a depth of standing water. When the sensing data from the water level sensor indicates there being standing water, the management platform calculates the cumulative duration to obtain the soaking time.

In some embodiments, the management platform may determine the sampling quantity based on the pipeline material and the soaking time by querying a first preset table. The first preset table includes sampling quantities corresponding to different pipeline materials and different soaking times. The first preset table may be constructed by the technician based on experience. Merely by way of example, when constructing the first preset table, the sampling quantity is directly proportional to a susceptibility to corrosion of the pipeline material and the soaking time.

After determining the sampling quantity, the management platform takes a ratio of the sampling radius to the sampling quantity as a sampling spacing and determines the sampling location of each sampling point.

In some embodiments of the present disclosure, by dynamically correlating the sampling strategy with the pipeline material and the soaking time, the intelligent and refined management of the data collection process is realized, and the sampling efficiency is significantly improved.

The inspection robot refers to a robot that is capable of moving and collecting water samples in water or on land. For example, the inspection robot is a robot with functions such as remote control, navigation, obstacle avoidance, and data transmission, and is set up with a plurality of sensors for monitoring water. The inspection robot is configured to collect the water data.

The water data refers to data related to water affected by flooding or waterlogging. In some embodiments, the water data may include conductivity of the water, compositions and proportions of the water, and a depth distribution of the water. The conductivity of the water reflects the ability of the water to corrode the pipeline. The depth distribution of the water (also referred to as a horizontal depth distribution of the water, an underwater topography) may be mapped by the inspection robot by continuously recording 3D coordinate points as the inspection robot moves on the water surface or underwater.

The unmanned aircraft is configured to collect the image data. The unmanned aircraft includes a visible light camera and an infrared imager. The visible light camera is configured to acquire a sequence of water surface images. The infrared imager is configured to acquire infrared thermography images.

In some embodiments, the image data includes the sequence of the water surface images captured by the visible light camera on the unmanned aircraft, and infrared thermography images captured by the infrared imager.

In some embodiments, after determining the sampling locations, the management platform controls the inspection robot to travel to the sampling locations and collect the water data; and controls the unmanned aircraft to move to the sampling locations and collect the image data.

In 222, the corrosion risk and the deformation risk of the suspected leakage point is determined based on the water data and the image data.

The corrosion risk refers to a risk of damage to the pipeline caused by chemical factors.

In some embodiments, the management platform processes the sequence of water surface images using an image recognition technology to determine a percentage of water surface bubbles; and determines the corrosion risk by querying a second preset table based on the percentage of the water surface bubbles, the conductivity of the water, and the compositions and proportions of the water.

The percentage of the water surface bubbles refers to an area ratio of the water surface bubbles to the water surface. The greater the percentage of the water surface bubbles, the stronger the impact and corrosiveness of floods. The image recognition technology is prior art and will not be repeated.

The second preset table includes corrosion risks corresponding to different percentages of the water surface bubbles, different conductivities of the water, and different compositions and different proportions of the water. The second preset table may be constructed by the technician based on experience. Merely by way of example, when constructing the second preset table, the corrosion risk is directly proportional to the percentage of the water surface bubbles, the conductivity of the water, and a proportion of corrosive components in the compositions and the proportions of the water.

Through multi-modal data such as the percentage of the water surface bubbles and the conductivity of the water, it is possible to obtain a more accurate corrosion risk.

The deformation risk refers to a risk of damage to the pipeline caused by physical factors. In some embodiments, the management platform may determine the deformation risk of the suspected leakage point in a variety of ways based on the water data and the image data.

In some embodiments, the management platform determines the deformation risk based on the depth distribution of the water and the infrared thermography images.

In some embodiments, the management platform may determine the deformation risk by querying a third preset table based on the depth distribution of the water and the infrared thermography images. The third preset table includes deformation risks corresponding to different depth distributions of the water and different infrared thermography images. The third preset table may be constructed by the technician based on experience. Merely by way of example, the depth distribution of the water in the historical data is compared to an acquired initial depth distribution of the water to determine a value of surface settlement, the larger the value of surface settlement, the higher the deformation risk. A low-temperature region and a corresponding temperature of the infrared thermography images in the historical data (due to rapid expansion and heat absorption of gas leakage points, localized low-temperature is manifested) are acquired, and when the low-temperature region is the largest and the temperature is the lowest, the deformation risk is the highest.

In 230, a comprehensive risk of a target pipeline node is determined using a prediction model based on a plurality of corrosion risks and a plurality of deformation risks of the plurality of suspected leakage points.

The prediction model is a model for predicting the comprehensive risk of the target pipeline node. In some embodiments, the prediction model may be a graph neural network (GNN) model.

The target pipeline node refers to a pipeline node of which the comprehensive risk is desired to be determined. The target pipeline node may include all nodes in the pipeline nodes except the suspected leakage points. In some embodiments, the target pipeline node may also refer to a supplementary collection node, and the target pipeline node and the supplementary collection node are interchangeable. More descriptions regarding the supplementary collection node may be found in the following descriptions.

The comprehensive risk refers to the likelihood of damage (e.g., corrosion and deformation) to the pipeline in the current flooding environment. The corrosion risk, the deformation risk, and the comprehensive risk may all be expressed as a percentage in order to quantify the risk.

FIG. 3 is a flowchart of an exemplary prediction model according to some embodiments of the present disclosure.

In some embodiments, the nodal attribute of the gas pipeline network map further includes the corrosion risk and the deformation risk. The management platform updates the gas pipeline network map based on the plurality of corrosion risks and the plurality of deformation risks of the plurality of suspected leakage points. The management platform determines the corrosion risks and the deformation risks of the plurality of suspected leakage points determined in the previous operations as new nodal attributes, and updates the new nodal attributes to corresponding nodal attributes in the gas pipeline network map.

An input of the prediction model 320 includes the updated gas pipeline network map 311 and the target pipeline node 312. In some embodiments, the input of the prediction model 320 may include only the updated gas pipeline network map 311. The target pipeline node 312 is defaulted to all the pipeline nodes of the gas pipeline network map 311 except for the suspected leakage points. In other embodiments, the target pipeline node 312 needs to be a separate input, e.g., the target pipeline node 312 is only the "target pipeline node determined based on a node importance degree" mentioned later. The output of the prediction model 320 includes a comprehensive risk 330 of the target pipeline node.

In some embodiments, the prediction model may be obtained by training a plurality of first training samples with first labels. For example, the management platform may input the plurality of first training samples into an initial prediction model, construct a loss function based on outputs of the initial prediction model and the first labels, and iteratively update parameters of the initial prediction model based on the loss function. When an iteration completion condition is satisfied, the iteration is terminated, and a trained prediction model is obtained. Methods for iterative updating include, but are not limited to, gradient descent, and the iteration completion condition may be either the loss function converging or a count of iterations reaching a threshold.

The first training samples may be obtained based on historical data. The first training sample includes a historical gas pipeline network map and a historical target pipeline node in the historical data. The first label is an actual comprehensive risk corresponding to the historical target pipeline node in the first training sample. The first label may be constructed in the following manner: a real corrosion depth and a real deformation size corresponding to each node (or each historical target pipeline node) in the first training sample are weighted and summed after being normalized to dimensionless values as the first label of the node. The real corrosion depth and the real deformation size may be obtained from historical pipeline leakage information or historical maintenance records.

In some embodiments, the comprehensive risk may also include a regional risk. The regional risk refers to a comprehensive risk corresponding to a sub-region. The sub-region may be preset by the technician based on, for example, an administrative zone. In some embodiments, the management platform determines the sub-region based on the plurality of corrosion risks, the plurality of deformation risks, and the gas pipeline network map. More descriptions regarding determining the sub-region may be found in the following descriptions.

In some embodiments, the management platform is further configured to simultaneously determine the comprehensive risk of the target pipeline node and the regional risk of the sub-region using the prediction model. The input of the prediction model further includes the sub-region, and the output includes the regional risk of the sub-region. The first training sample further includes a historical sub-region in the historical data. The corresponding first label further includes an actual comprehensive risk of the sub-region, which may be an average of the actual comprehensive risks corresponding to the plurality of pipeline nodes within the sub-region. More descriptions regarding the sub-region and the regional risk may be found in the following descriptions.

In 240, in response to the comprehensive risk meeting a drainage condition, a control signal is automatically sent to a drainage robot to drive the drainage robot to carry out drainage.

The drainage condition refers to a condition that controls the drainage robot to carry out the drainage. In some embodiments, the drainage condition is that the comprehensive risk of the target pipeline node is greater than a risk threshold. The risk threshold may be preset.

In some embodiments, the control signal includes a drainage power of the drainage robot. The drainage robot carries out the drainage based on the drainage power.

In some embodiments, in response to a count of the plurality of suspected leakage points or a dispersity of the plurality of suspected leakage points meeting a supplementary collection condition, the management platform determines the supplementary collection node, and performs a process similar to the evaluating process of the suspected leakage point on the supplementary collection node. More descriptions regarding the evaluating process of the suspected leakage point may be found in the relevant descriptions of operation 221 - operation 222.

The dispersity of the plurality of suspected leakage points refers to a concentration degree of the suspected leakage points. The dispersity may be obtained by the management platform by calculating a variance of coordinates based on the coordinates of all the suspected leakage points. The smaller the variance, the lower the dispersity.

The supplementary collection condition includes that a count of the suspected leakage points is less than a preset count threshold, or the dispersity of the suspected leakage points is less than a preset dispersity threshold. The preset count threshold and the preset dispersity threshold may be set by the technician based on experience.

In some embodiments, the management platform sets nodes within a preset distance (e.g., 3-5 meters) around a suspected leakage point as the supplementary collection nodes. The preset distance is set by the technician based on experience. In some embodiments, the management platform determines the supplementary collection node based on the node importance degree. More descriptions regarding the node importance degree and the supplementary collection node may be found in the following descriptions.

When the count of the suspected leakage points is too small, or the distribution of the suspected leakage points is too centralized, it means that only collecting data from these high-risk points may not provide sufficiently comprehensive and representative information for subsequent risk assessment of the entire pipeline network. Therefore, when the supplementary collection condition is met, the management platform may ensure the global coverage of the collected data by determining the supplementary collection nodes, thereby preventing a decline in the accuracy of the prediction model subsequently due to sampling bias.

In some embodiments of the present disclosure, by updating the corrosion risk and the deformation risk assessed and collected on-site as dynamic features into the gas pipeline network map and utilizing a GNN model for learning and reasoning, it is possible to take full advantage of the topological structure information of the pipeline network and the spatial correlation of the risk data to achieve accurate risk assessment.

In some embodiments, the management platform is further configured to: determine at least one of the target pipeline node or the supplementary collection node based on a node importance degree. The node importance degree is correlated to the gas pipeline network map and a node dynamic risk.

The node importance degree is a level of importance of a pipeline node.

In some embodiments, the node importance degree is correlated to the gas pipeline network map and the node dynamic risk.

In some embodiments, the node importance degree is directly proportional to a count of edges in the topological structure of the gas pipeline network map and a count of paths passing through nodes and is inversely proportional to the path length of the nodes. The specific proportional relationship may be preset. For example, for a certain pipeline node, the greater the count of edges connected to the certain pipeline node and the shorter the total path length from the certain pipeline node to all other nodes, the higher the node importance degree of the certain pipeline node.

The node dynamic risk refers to a risk that the negative impact of a node is amplified during a flood environment after the node fails. The node dynamic risk may be determined by performing a weighted summation based on normalized results of the betweenness centrality of nodes in the gas pipeline network map and the node failure flood simulation, which yields a dimensionless value. The normalization processing may include Min-Max normalization, etc.

The betweenness centrality of a node may indicate the influence of the node in the gas pipeline network map. The betweenness centrality of the node is determined as follows: determine all node pairs (i.e., a pair is composed of any two selected nodes) in the gas pipeline network map; for each node pair, determine the shortest path (i.e., the shortest path among all possible paths between the two selected nodes); for a certain node, count a count of times the node appears in the shortest paths. The betweenness centrality of the node is a ratio of the count of times the node appears to a count of the total shortest paths.

The node failure flood simulation refers to modeling a leakage range of gas of a node altered by the flooding after the node ruptures. The node failure flood simulation may be conducted using existing fluid dynamics simulation software, such as ANSYS Fluent, Flow-3D, or other commercially available tools.

Merely by way of example, for a certain pipeline node, the greater the betweenness centrality of the node, and the greater the leakage range of the node failure flood simulation, the greater the node dynamic risk.

In some embodiments, a final node importance degree may be an average of two node importance degrees obtained based on the gas pipeline network map and the node dynamic risk as described above.

By considering the node dynamic risk, the approach not only evaluates an individual node but also examines whether the negative impact of the node is propagated and amplified downstream or to other regions through water flow and network topology in the case of a failure of the node in a flooding environment.

The target pipeline node or the supplementary collection node may be a top-ranked node in terms of the node importance degree. Considering the node importance degree can prioritize the risk of important nodes or prioritize data collection on the important nodes, thereby improving efficiency.

In some embodiments, the management platform is further configured to: determine the at least one of the target pipeline node or the supplementary collection node based on the gas pipeline network map, map information, and the node dynamic risk using a node selection model.

The node selection model refers to a model for determining the target pipeline node. In some embodiments, the node selection model is a graph neural network model.

Inputs of the node selection model include the gas pipeline network map and the map information. The nodal attribute of the gas pipeline network map includes the node dynamic risk. Outputs of the node selection model include one or more target pipeline nodes determined based on nodes. The map information includes a building density of each of the plurality of pipeline nodes. The building density refers to a density of buildings around a node. The building density may be obtained statistically based on publicly available map information. More descriptions regarding the gas pipeline network map may be found in FIG. 2.

In some embodiments, the node selection model may be obtained by a plurality of second training samples with second labels. A training process of the node selection model is similar to that of the prediction model and may be found in related descriptions of FIG. 3.

The second training samples include sample gas pipeline network maps, sample map information, and sample node dynamic risks. The second training sample may be obtained based on the historical data. The second labels include target pipeline nodes and supplementary collection nodes corresponding to the second training samples. The second labels may be manually labeled. For example, a node in the sample gas pipeline network map where a leakage actually occurs is identified as a target pipeline node.

Understandably, determining the supplementary collection node may be done in the same manner as determining the target pipeline node, and will not be repeated.

In some embodiments, the second label is determined based on a relationship between the building density of the second training sample and a density threshold, and a relationship between the node dynamic risk of the second training sample and the dynamic risk threshold. For example, a pipeline node that simultaneously meets building density greater than the density threshold, and the node dynamic risk greater than the dynamic risk threshold is labeled as the target pipeline node. More descriptions regarding the node dynamic risk may be found in the previous section.

In some embodiments, the density threshold and the dynamic risk threshold are inversely proportional to a historical rainfall of the second training sample and a count of abnormal occurrences of historical outside pressure anomalies of the second training sample. The specific proportional relationship may be preset. For example, for each node of the second training sample, the higher the historical rainfall corresponding to the node and the greater the count of abnormal occurrences, the lower the density threshold and the dynamic risk threshold. The historical rainfall can be obtained from publicly available weather data.

An outside pressure of a pipeline refers to an external force on the outside wall of the pipeline. The outside pressure of the pipeline may be obtained by a pressure sensor set on the outside wall of the pipeline.

When the outside pressure exceeds a preset range, the outside pressure of the pipeline is considered abnormal (or the outside pressure anomaly of the pipeline). The preset range may be preset by the technician based on experience. The count of abnormal occurrences of the historical outside pressure anomalies may be obtained based on the statistical analysis of the historical outside pressure anomalies. For example, the statistical period may be one hour or one day, i.e., if an anomaly occurs within 1 hour or 1 day, it is recorded as 1.

By optimizing the second labels of the second training samples, the node selection model can be optimized, which makes the node selection model output appropriate target pipeline node.

In some embodiments, the management platform is further configured to: determine the sub-region based on the plurality of corrosion risks, the plurality of deformation risks, and the gas pipeline network map; determine the comprehensive risk of the target pipeline node and the regional risk of the sub-region using the prediction model; and in response to the comprehensive risk meeting the drainage condition, and the regional risk of the sub-region being greater than a regional risk threshold, drive the drainage robot to move to a regional center of the sub-region to be drained for drainage.

In some embodiments, the sub-region includes the regional center and an intra-regional node.

Based on the plurality of corrosion risks, the plurality of deformation risks, and the gas pipeline network map, determining the sub-region includes: taking each node of the gas pipeline network map as a unit, and determining the sub-region based on the plurality of corrosion risks and the plurality of deformation risks of the plurality of suspected leakage points by clustering. Each cluster obtained by the clustering is a sub-region, and a clustering center of each cluster is the regional center of the sub-region. A node contained in the sub-region is the intra-regional node.

In some embodiments, prior to clustering, the process also involves normalizing the corrosion risk and deformation risk of the suspected leakage point into dimensionless values, weighting and clustering the dimensionless values. Clustering algorithms include K-means clustering, density-based clustering approach (DBSCAN), etc.

When the nodes of the plurality of comprehensive risks are relatively concentrated, relying only on the comprehensive risks of the nodes may lead to over-concentration of the drainage robots; by dividing the sub-region and determining the regional risk of the sub-region, the regional center can be quickly located, and the drainage robots can be reasonably allocated.

In some embodiments, each sub-region corresponds to a different regional risk threshold. The regional risk threshold is related to a pipeline age, a pipeline length, and the historical rainfall corresponding to the sub-region.

The pipeline age and the pipeline length corresponding to the sub-region may be determined from the gas pipeline network map. The pipeline age corresponding to the sub-region may be an average pipeline age of a plurality of pipelines within the sub-region. The pipeline length corresponding to the sub-region may be a total length of the plurality of pipelines within the sub-region.

More descriptions regarding this section may be found in related descriptions of FIG. 2 and FIG. 3.

In some embodiments, the management platform may determine the regional risk threshold by querying a fourth preset table based on the pipeline age, the pipeline length, and the historical rainfall corresponding to the sub-region. The fourth preset table includes the regional risk threshold corresponding to the pipeline age, the pipeline length, and the historical rainfall corresponding to the sub-region. The fourth preset table may be constructed by the technician based on experience. Merely by way of example, when constructing the fourth preset table, the regional risk threshold of the sub-region is inversely proportional to the pipeline age, the pipeline length, and the historical rainfall corresponding to the sub-region, i.e., the larger the pipeline age, the longer the pipeline length, and the more the historical rainfall corresponding to the sub-region, the smaller the regional risk threshold.

The larger the pipeline age, the longer the pipeline length, and the more the historical rainfall, the easier it is for the regional risk of the sub-region to meet the condition, so that early drainage can be carried out in the sub-region to avoid pipeline damage. Meanwhile, the sub-region with a more historical rainfall has the potential to further increase in waterlogging, and early drainage for the sub-region can prevent the expansion of flooding.

In some embodiments, a drainage power of the drainage robot is positively correlated to the comprehensive risk of the target pipeline node and the regional risk of the sub-region. The drainage power is directly proportional to the comprehensive risk of the target pipeline node, or the regional risk of the sub-region. The specific proportional relationship may be preset. For example, the drainage power is the maximum drainage power when the comprehensive risk of the target pipeline node or the regional risk of the sub-region is the highest (e.g., 95%).

By setting a drainage power that matches the comprehensive risk, the flooding impact can be reduced by drainage as early as possible for a region with a high comprehensive risk.

In some embodiments, the management platform is further configured to: in response to the corrosion risk at any of the plurality of suspected leakage points being greater than a corrosion threshold, control the drainage robot to move to the corresponding suspected leakage point and activate a protection electrode. The protection electrode is electrically connected to a pipeline wall at the suspected leakage point. The corrosion threshold may be preset by the technician based on experience.

The protection electrode refers to a device that reduces corrosion by electrochemical means (e.g., cathodic protection). The protection electrode forms a closed circuit with the pipeline wall at the suspected leakage point through an electrical connection to change the electrochemical state of the metal surface of the pipeline and reduce the corrosion of the pipeline wall by liquid. The protection electrode may be set on the drainage robot. Merely by way of example, the protection electrode is set on a side of the drainage robot, and when the drainage robot moves to the vicinity of the pipeline wall of the suspected leakage point, the protection electrode is tightly attached to the pipeline wall and activated.

In some embodiments, the management platform is further configured to: before determining the plurality of suspected leakage points and the plurality of leakage confidence levels, in response to an outside pressure anomaly of the pipeline, send a control signal to a target valve to reduce an opening degree of the target valve to reduce the pipeline pressure. The target valve is located at an upstream node of a pressure sensor corresponding to the outside pressure anomaly.

The target valve refers to a valve that can reduce the pipeline pressure at the position corresponding to the outside pressure anomaly after lowering the opening degree of the valve. The opening degree of the target valve refers to an opening size of the target valve, which corresponds to a flow size of the pipeline.

The management platform may identify an upstream node that is closest to the pressure sensor corresponding to the outside pressure anomaly among the nodes with valves set up as the target valve. The closest upstream node may be determined based on the gas pipeline network map. For example, if the gas flow direction is from a node A to a node B and then to a node C, and the pressure sensor corresponding to the outside pressure anomaly is located at the node C, and the node A is provided with a valve and the node B is not provided with a valve, the target valve is the node A.

In the early stage of flooding, when soil loosening around buried pipelines or increased pressure in exposed pipelines occurs due to the flooding, an early warning of the outside pressure anomaly can be triggered, and the pressure in the pipeline network can be reduced, or valves in high-risk regions can be closed in advance, thereby reducing the risk of pipeline rupture.

The basic concepts have been described above, and it is apparent to a person skilled in the art that the above detailed disclosure serves only as an example and does not constitute a limitation of the present disclosure. While not expressly stated herein, various modifications, improvements, and amendments may be made to the present disclosure by those skilled in the art. Those types of modifications, improvements, and amendments are suggested in the present disclosure, so those types of modifications, improvements, and amendments are still within the spirit and scope of the exemplary embodiments of the present disclosure.

WHAT IS CLAIMED IS:

1. A system for emergency prevention and control for urban lifeline gas pipelines during flooding based on a large model, wherein the system comprises an emergency supervision-management platform; and the emergency supervision-management platform is configured to:
construct a gas pipeline network map based on pipeline pressures and gas flow rates of a plurality of pipeline nodes;
determine a plurality of suspected leakage points and a plurality of leakage confidence levels of the plurality of suspected leakage points;
perform an evaluating process on each suspected leakage point of the plurality of suspected leakage points, wherein the evaluating process includes:
determining a sampling radius based on the leakage confidence level of the suspected leakage point;
controlling an inspection robot to travel to the suspected leakage point to collect water data;
controlling an unmanned aircraft to move to the suspected leakage point to collect image data; and
determining a corrosion risk and a deformation risk of the suspected leakage point based on the water data and the image data;
determine, based on a plurality of corrosion risks and a plurality of deformation risks of the plurality of suspected leakage points, a comprehensive risk of a target pipeline node using a prediction model; and
in response to the comprehensive risk meeting a drainage condition, automatically send a control signal to a drainage robot to drive the drainage robot to carry out drainage.

2. The system of claim 1, wherein the emergency supervision-management platform is further configured to:
for each suspected leakage point,
determine a sampling quantity and sampling locations of a plurality of sampling points within the sampling radius based on a pipeline material and a soaking time of the suspected leakage point; and
automatically control the inspection robot and the unmanned aircraft to sample based on the sampling quantity and the sampling locations of the plurality of sampling points.

3. The system of claim 1, wherein the emergency supervision-management platform is further configured to:
in response to a count of the plurality of suspected leakage points or a dispersity of the plurality of suspected leakage points meeting a supplementary collection condition, determine a supplementary collection node; and
perform a process same as the evaluating process on the supplementary collection node.

4. The system of claim 3, wherein the emergency supervision-management platform is further configured to:
determine at least one of the target pipeline node or the supplementary collection node based on a node importance degree, wherein the node importance degree is correlated to the gas pipeline network map and a node dynamic risk.

5. The system of claim 4, wherein the emergency supervision-management platform is further configured to:
determine the at least one of the target pipeline node or the supplementary collection node based on the gas pipeline network map, map information, and the node dynamic risk using a node selection model, wherein the map information includes a building density of each of the plurality of pipeline nodes, and the node selection model is a graph neural network model.

6. The system of claim 5, wherein the emergency supervision-management platform is further configured to:
determine the node selection model based on a plurality of training samples with labels, wherein
a label corresponding to a training sample is determined based on a relationship between a building density of the training sample and a density threshold, and a relationship between a node dynamic risk of the training sample and a dynamic risk threshold, wherein
the density threshold and the dynamic risk threshold are related to a historical rainfall of the training sample, and a count of abnormal occurrences of historical outside pressure anomalies of the training sample.

7. The system of claim 1, wherein the gas pipeline network map comprises the plurality of pipeline nodes, and a nodal attribute of each of the plurality of pipeline nodes comprises a corrosion risk and a deformation risk;
the emergency supervision-management platform is further configured to:
update the gas pipeline network map based on the plurality of corrosion risks and the plurality of deformation risks of the plurality of suspected leakage points, wherein
the prediction model is a graph neural network model, and an
input of the prediction model includes the updated gas pipeline network map and the target pipeline node.

8. The system of claim 1, wherein the comprehensive risk includes a regional risk, and the emergency supervision-management platform is further configured to:
determine a sub-region based on the plurality of corrosion risks, the plurality of deformation risks, and the gas pipeline network map;
determine the comprehensive risk of the target pipeline node and a regional risk of the sub-region using the prediction model; and
in response to the comprehensive risk meeting the drainage condition, and the regional risk of the sub-region being greater than a regional risk threshold, drive the drainage robot to move to a regional center of the sub-region to be drained for drainage.

9. The system of claim 8, wherein each sub-region corresponds to a different regional risk threshold, the regional risk threshold being related to a pipeline age, a pipeline length, and the historical rainfall corresponding to the sub-region.

10. The system of claim 8, wherein a drainage power of the drainage robot is positively correlated to the comprehensive risk of the target pipeline node and the regional risk of the sub-region.

11. The system of claim 8, wherein the emergency supervision-management platform is further configured to:
in response to the corrosion risk at any of the plurality of suspected leakage points being greater than a corrosion threshold, control the drainage robot to move to the corresponding suspected leakage point and activate a protection electrode, wherein the protection electrode is electrically connected to a pipe wall at the suspected leakage point.

12. The system of claim 8, wherein the emergency supervision-management platform is further configured to:
before determining the plurality of suspected leakage points and the plurality of leakage confidence levels, in response to an outside pressure anomaly of a pipeline, send a control signal to a target valve to reduce an opening degree of the target valve to reduce pipeline pressure, wherein the target valve is located at an upstream node of a pressure sensor corresponding to the outside pressure anomaly.

13. A method for emergency prevention and control for urban lifeline gas pipelines during flooding based on a large model, performed by an emergency supervision-management platform, wherein the method comprises:
constructing a gas pipeline network map based on pipeline pressures and gas flow rates of a plurality of pipeline nodes;
determining a plurality of suspected leakage points and a plurality of leakage confidence levels of the plurality of suspected leakage points; and
performing an evaluating process on each suspected leakage point of the plurality of suspected leakage points, wherein the evaluating process includes:
determining a sampling radius based on the leakage confidence level of the suspected leakage point;
controlling an inspection robot to travel to the suspected leakage point to collect water data;
controlling an unmanned aircraft to move to the suspected leakage point to collect image data; and
determining a corrosion risk and a deformation risk of the suspected leakage point based on the water data and the image data;
determining, based on a plurality of corrosion risks and a plurality of deformation risks of the plurality of suspected leakage points, a comprehensive risk of a target pipeline node using a prediction model; and
in response to the comprehensive risk meeting a drainage condition, automatically sending a control signal to a drainage robot to drive the drainage robot to carry out drainage.

14. The method of claim 13, further comprising:
in response to a count of the plurality of suspected leakage points or a dispersity of the plurality of suspected leakage points meeting a supplementary collection condition, determining a supplementary collection node; and performing a process same as the evaluating process on the supplementary collection node.

15. The method of claim 14, further comprising:
determining at least one of the target pipeline node or the supplementary collection node based on a node importance degree, wherein the node importance degree is correlated to the gas pipeline network map and a node dynamic risk.

16. The method of claim 15, further comprising:
determining the at least one of the target pipeline node or the supplementary collection node based on the gas pipeline network map, map information, and the node dynamic risk using a node selection model, wherein the map information includes a building density of each of the plurality of pipeline nodes, and
the node selection model is a graph neural network model.

17. The method of claim 16, wherein the node selection model is obtained by training based on a plurality of training samples with labels, wherein
a label corresponding to a training sample is determined based on a relationship between a building density of the training sample and a density threshold, and a relationship between a node dynamic risk of the training sample and a dynamic risk threshold, wherein
the density threshold and the dynamic risk threshold are related to a historical rainfall of the training sample, and a count of abnormal occurrences of historical outside pressure anomalies of the training sample.

18. The method of claim 13, wherein the gas pipeline network map comprises the plurality of pipeline nodes, and a nodal attribute of each of the plurality of pipeline nodes comprises a corrosion risk and a deformation risk; and
the determining, based on a plurality of corrosion risks and a plurality of deformation risks of the plurality of suspected leakage points, a comprehensive risk of a target pipeline node using a prediction model includes:
updating the gas pipeline network map based on the plurality of corrosion risks and the plurality of deformation risks of the plurality of suspected leakage points, wherein
the prediction model is a graph neural network model, and
an input of the prediction model includes the updated gas pipeline network map and the target pipeline node.

19. The method of claim 13, wherein the comprehensive risk includes a regional risk, wherein
the determining, based on a plurality of corrosion risks and a plurality of deformation risks of the plurality of suspected leakage points, a comprehensive risk of a target pipeline node using a prediction model includes:
determining a sub-region based on the plurality of corrosion risks, the plurality of deformation risks, and the gas pipeline network map; and
determining the comprehensive risk of the target pipeline node and a regional risk of the sub-region using the prediction model; and
the in response to the comprehensive risk meeting a drainage condition, automatically sending a control signal to a drainage robot to drive the drainage robot to carry out drainage includes:
in response to the comprehensive risk meeting the drainage condition, and the regional risk of the sub-region being greater than a regional risk threshold, drive the drainage robot to move to a regional center of the sub-region to be drained for drainage.
in response to the comprehensive risk meeting the drainage condition, and the regional risk of the sub-region being greater than a regional risk threshold, drive the drainage robot to move to a regional center of the sub-region to be drained for drainage.

20. The method of claim 19, further comprising:
before determining the plurality of suspected leakage points and the plurality of leakage confidence levels, in response to an outside pressure anomaly of a pipeline, sending a control signal to a target valve to reduce an opening degree of the target valve to reduce pipeline pressure, wherein the target valve is located at an upstream node of a pressure sensor corresponding to the outside pressure anomaly.
